(19) United States
(12) Patent Application Publication
(10) Pub. No.: US 2015/0316135 A1
(43) Pub. Date: Nov. 5, 2015

(54) GEARWHEEL FOR A BACKLASH-FREE TRANSMISSION STAGE AND TRANSMISSION STAGE EQUIPPED THEREWITH

(71) Applicant: Magna Powertrain AG & Co KG, Lannach (AT)

(72) Inventor: Klaus Schnölzer, Kirchberg (AT)

(21) Appl. No.: 14/682,369

(22) Filed: Apr. 9, 2015

(30) Foreign Application Priority Data
Apr. 30, 2014 (DE) 102014208268.4

(51) Int. Cl. F16H 55/18

(52) U.S. Cl. CPC F16H 55/18

(57) ABSTRACT

A gearwheel and of a transmission stage fitted with a gearwheel of this kind. The gearwheel comprises a gear rim having a first gear rim part and of a second gear rim part arranged coaxially therewith. The two gear rim parts can be turned relative to one another about an axis of rotation. The gearwheel furthermore comprises a spring situated between the two gear rim parts and which acts in the circumferential direction for preloading the two gear rim parts relative to one another. The gearwheel also includes damping means which damps relative movements between the first gear rim part and/or the second gear rim part and/or the spring. The transmission stage comprises at least one intermeshing gearwheel pair, wherein one wheel of the gearwheel pair is embodied as the gearwheel described above.

### CROSS-REFERENCE TO RELATED APPLICATIONS

This application claims the benefit and priority of German Application No. 102014208268.4 filed Apr. 30, 2014. The entire disclosure of the above application is incorporated herein by reference.

### TECHNICAL FIELD

The present invention relates to a gearwheel for a backlash-free transmission stage and to a transmission stage having at least one intermeshing gearwheel pair, wherein one wheel of the gearwheel pair is embodied as a gearwheel for a backlash-free transmission stage.

### BACKGROUND

This section provides background information related to the present disclosure which is not necessarily prior art.

In transmission stages, it may be the case that, owing to a desire for low noise levels for example, use is made of one or more gearwheels designed so that they do not have any backlash relative to one or more wheels meshing with the gearwheel when it comes to turning of a wheel relative to the gearwheel. A gearwheel for performing such a task, commonly referred to as a divided gearwheel, a scissors gearwheel or as a “split gear” for use in a backlash-free transmission stage, is known.

DE 7345374 discloses a transmission stage in which a wheel of an intermeshing gearwheel pair, primarily the driving wheel, is embodied as a scissors gearwheel which has a gear rim consisting of two gear rim parts preloaded relative to one another by a spring situated between them and acting in a circumferential direction. One of the two gear rim parts is used for torque transmission, whereas the other performs backlash compensation.

DE 201 04 777 U1 discloses a gearwheel for a backlash-free spur wheel stage. The gearwheel has a hub, a gear rim supported by the hub, and an annular spring surrounding the hub. The gear rim is divided into two gear rim parts along a parting plane extending normally to an axis of rotation of the gearwheel. One of the gear rim parts is a rim part fixed to the hub, whereas the other gear rim part is a rim ring mounted so as to be rotatable relative to said rim part, coaxially around the axis of rotation. By means of its opposite ends in the circumferential direction, the annular spring is supported on abutments in the form of stops, on the one hand on the rim part fixed to the hub and, on the other hand, on the rim ring. The two ends of the annular spring are supported under a preload on at least one of the stops, which are offset radially relative to one another and can be moved past one another in the circumferential direction when the rim ring is rotated relative to the rim part.

Common to such known gearwheels is the disadvantage of unsatisfactory mass balancing, the result being, depending on the speed of rotation at which such a gearwheel is moving, on the one hand in-phase and/or out-of-phase torsional vibrations and, in the worst case, resonant vibrations of the gear rim parts that can turn relative to one another and/or vibrations of the spring, which can even lead to destruction of the gearwheel and of a transmission stage fitted therewith and, on the other hand, vibrations of the spring, embodied as an annular spring for example, which spring supplies the preload between the two gear rim parts and is also referred to as a biasing spring. Even if this does not lead to immediate failure, it causes increased wear, for instance on abutments on which the biasing spring is fixed by its two ends on the two gear rim parts. The abutments being embodied, for example, as pins which engage in corresponding annular openings at the two ends of the biasing spring, and/or increased wear on the biasing spring itself, e.g. on the openings which have been described, by means of which the biasing spring is fixed by its two ends on correspondingly designed abutments, and/or increased wear on corresponding abutments, embodied as stops, for the two ends of the biasing spring and/or on the two ends of the biasing spring. In summary, this leads to a reduction in the life of the known gearwheels combined with a reduced operational reliability.

### SUMMARY

This section provides a general summary of the present disclosure and is not intended to be a comprehensive disclosure of its full scope of all of its objects, aspects and features.

It is an object of the present disclosure to provide a gearwheel for use in a backlash-free transmission stage as well as a transmission stage equipped with such a gearwheel to provide increased operational reliability.

The above object is achieved by a gearwheel for a backlash-free transmission stage comprised of a gear rim having a first gear rim part and a second gear rim part which is arranged coaxially with the first gear rim part such that the two gear rim parts can be turned relative to one another about an axis of rotation. The gearwheel also includes a spring, situated between the two gear rim parts, and which acts in the circumferential direction and preloads the two gear rim parts relative to one another, and a damping means which damps relative movements between the first gear rim part and/or the second gear rim part and/or the spring.

The object is also achieved by a transmission stage having at least one intermeshing gearwheel pair, wherein one wheel of the gearwheel pair is embodied as a gearwheel for a backlash-free transmission stage having a gear rim including two gear rim parts which can be turned relative to one another about an axis of rotation of the gearwheel and which are preloaded relative to one another by a spring situated therebetween which acts in the circumferential direction, having a gearwheel as described above.

Accordingly, a first aspect of the present disclosure relates to a gearwheel for a backlash-free transmission stage. The gearwheel, which can also be referred to as a divided gearwheel, a scissors gearwheel, or as a “split gear”, includes a gear rim having a first gear rim part and a second gear rim part which are arranged coaxially and which can be turned relative to one another about an axis of rotation. The two gear rim parts are preloaded relative to one another by a spring which is situated between the two gear rim parts and acts in the circumferential direction.

One of the first and second gear rim parts is used for torque transmission, whereas the other of the first and second gear rim parts performs backlash compensation.

The axis of rotation is a geometrical feature, similar to a mirror axis or axis of rotational symmetry, not a feature in the sense of a mechanical element, such as a shaft. The axis of rotation is normal to a plane enclosed by the gear rim and/or formed by the latter. For example, this plane can be a parting plane which divides the gear rim into its gear rim parts. The axis of rotation passes through the centre of the gear rim, which coincides with the geometrical centre of gravity of the gear rim, when viewed in a plane extending orthogonally to the axis of rotation. The gearwheel is further characterized by damping means which damp relative movements between the first gear rim part and/or the second gear rim part and/or the spring. The damping means provide a tangential damping effect in relation to the direction of loading of the spring.

Damping in the sense according to the present invention denotes the phenomenon according to which the amplitude of a vibration of a system which is capable in principle of vibrating, as described at the outset in respect of the prior art, said system consisting of a first and a second gear rim part and a spring which preloads them relative to one another in the circumferential direction, decreases with time or according to which no vibration at all can occur, depending on the circumstances.

The relative movements can comprise torsional vibrations between the two gear rim parts and/or vibrations between the spring and at least one of the two gear rim parts and/or vibrations of the spring.

The two gear rim parts can have a rest position, in which they adopt a position relative to one another, in respect of mutual turning in relation to the axis of rotation, in which the spring is not capable of turning either of the two gear rim parts relative to the other gear rim part. In the rest position, the spring can be relaxed and/or the turning of the two gear rim parts relative to one another can be blocked in one direction by one or more stops and/or the spring acts in both cases on each of the two gear rim parts with forces of equal magnitude in opposite directions.

The spring preloads the two gear rim parts relative to one another, at least outside the rest position.

The damping means can damp relative movements at least in the rest position, and/or around the rest position.

The damping means can have one or more elements made of a flexible material that absorbs kinetic energy stemming from a relative movement between the first gear rim part and/or the second gear rim part and/or the spring.

The flexible material that absorbs kinetic energy can be rubber and/or a rubber compound and/or a rubber-like material, to mention just a few conceivable embodiments.

The damping means can comprise one or more impact dampers. The impact dampers preferably damp relative movements leading to the rest position.

Increasing damping can be provided with increasing proximity to the rest position.

The gearwheel can have an abutment for each of the opposite ends of the spring on each gear rim part.

The spring can be supported by means of the opposite ends thereof on abutments of the first gear rim part, on the one hand, and of the second gear rim part, on the other hand. In this case, the spring can be supported under a preload against the two abutments on the first and second gear rim parts in the rest position. Here, the preload is brought about by a compression force. Transmission of tensile forces between the spring and the abutment is not envisaged with the support.

As an alternative, the spring can be fixed by means of the opposite ends thereof on the abutments, wherein the spring—in the region of the opposite ends thereof—and the abutments are connected positively to one another.

In order to enter a positive engagement, the abutments can, for example, be designed as pins which engage in corresponding openings in the opposite ends of the spring.

The abutments can be arranged on the two gear rim parts in such a way that that they pass one another as the two gear rim parts are turned. This can be accomplished, for example, by means of a radial offset of the two abutments relative to one another in relation to the axis of rotation of the gearwheel. An axial offset of the two abutments in relation to the axis of rotation is likewise conceivable.

The damping means can be provided at least in part between the abutment and the opposite ends of the spring. For example, the damping means can comprise one or more elements consisting of flexible material that absorbs kinetic energy arranged between the abutment and the opposite ends of the spring.

As an alternative or in addition, the damping means can be provided at least in part between at least one of the gear rim parts and the spring. For example, the damping means can comprise one or more elements consisting of flexible material that absorbs kinetic energy arranged between at least one of the gear rim parts and the spring.

The spring can be designed as an annular spring.

The damping means can be provided at least in part between at least one of the gear rim parts and the annular spring.

The damping means can preferably be provided at least in part between at least one of the gear rim parts and at least one of the two ends of the annular spring, which are situated opposite one another in the circumferential direction.

The annular spring can be supported by means of the ends thereof, which are situated opposite one another in the circumferential direction, on abutments of the first gear rim part, on the one hand, and of the second gear rim part, on the other hand, said abutments being designed as stops.

As an alternative, the annular spring can be fixed by means of the ends thereof, which are situated opposite one another in the circumferential direction, on abutments of the first gear rim part, on the one hand, and of the second gear rim part, on the other hand, said abutments being designed as pins, for example, wherein the spring—in the region of the opposite ends thereof—and the abutments are connected positively to one another.

The gearwheel can have a hub which is arranged coaxially with the axis of rotation of the gearwheel and carries the gear rim.

The spring, which is designed as an annular spring, for example, can surround the hub.

The two gear rim parts can rest snugly one upon the other and can be fixed axially by a snap ring retainer.

The spring, which is preferably designed as an annular spring, can be arranged in a correspondingly shaped recess in one or both gear rim parts, said recess being annular in the example of a spring designed as an annular spring.

The damping means can be provided at least in part between the spring, which is preferably embodied as an annular spring, and at least one wall bounding a recess in one or both gear rim parts radially towards the outside away from the axis of rotation.

The damping means can preferably be provided at least in part between at least one wall bounding a recess in one or both gear rim parts radially towards the outside away from the axis of rotation and at least one of the two ends, situated opposite one another in the circumferential direction, of the spring, which is preferably embodied as an annular spring.

As a particularly preferred option, the damping means comprise two elements consisting of flexible material that absorbs kinetic energy, which are arranged between the spring, which is preferably embodied as an annular spring, and a wall bounding a recess in one or both gear rim parts radially towards the outside away from the axis of rotation, being arranged in the region of the ends of the spring, one element for each end of the spring.

In this case, one element can be arranged between the region of one end of the spring and the first gear rim part, and one element can be arranged between the region of the remaining end of the spring and the second gear rim part.

In this arrangement, one end of the spring is preferably in operative connection with the first gear rim part, and the remaining end of the spring is preferably in operative connection with the second gear rim part in order to preload the two gear rim parts relative to one another in the circumferential direction.

As an alternative, both elements can be provided between the spring, in the region of the ends thereof, and a wall bounding a recess in just one gear rim part radially towards the outside away from the axis of rotation.

The gearwheel can have straight or bevel toothing or double or multiple bevels (V-, N-, W-shaped etc.).

The toothing of the gearwheel can comprise involute toothing or cycloid toothing or a combination of involute toothing and cycloid toothing. Moreover, other types of toothing are also conceivable for the gearwheel.

The gearwheel can be embodied as a spur wheel for a spur wheel stage, as an elliptical wheel for an elliptical wheel stage or as a bevel wheel for a bevel wheel stage, to name but a few conceivable embodiments. This list makes no claim to completeness.

It is contemplated that this part of the invention can be implemented by impact dampers, e.g. In the form of rubber buffers, which are installed in a gearwheel for a backlash-free transmission stage, which damp torsional vibrations of a first gear rim part of the gearwheel, which is arranged so as to be rotatable about the axis of rotation of the gearwheel relative to a second gear rim part of the gearwheel and which is spring-loaded relative to the second gear rim part in the circumferential direction by means of a biasing spring, and which reduce the amplitude of the torsional vibrations and avoid any hard impact between the first gear rim part and the second gear rim part at stops limiting the rotation thereof relative to one another and/or between one or both opposite ends of the biasing spring and one or both abutments connected rotationally to one of the gear rim parts in each case.

The gearwheel makes possible a reduction in wear together with increased service life and operational reliability.

A second aspect of the invention relates to a transmission stage in which one wheel of an intermeshing gearwheel pair, primarily the driving wheel, is embodied as a gearwheel described above, which includes a gear rim having two gear rim parts which are preloaded relative to one another by a spring, which is situated between them and acts in the circumferential direction. One of the two gear rim parts is used for torque transmission, whereas the other performs backlash compensation.

The transmission stage can be embodied as a spur wheel stage, as an elliptical wheel stage or as a bevel wheel stage, to name just a few conceivable embodiments. An embodiment in the form of a rack stage used, for example, as a linear drive is likewise conceivable.

Apart from complete achievement of the stated objects, advantages over the prior art are obtained inter alia through elimination of all the disadvantages of the prior art.

Further areas of applicability will become apparent from the description provided herein. The description and specific examples in the summary are intended for purposes of illustration only and are not intended to limit the scope of the present disclosure.

### DRAWINGS

The invention and the advantages thereof are explained in greater detail below by means of illustrative embodiments illustrated in the figures. The size ratios of the individual elements in the figures do not always correspond to the actual size ratios since, in the figures, some of the shapes are simplified and other shapes are illustrated on an enlarged scale in relation to other elements for greater clarity. Identical reference signs are used for elements of the invention which are the same or have the same action. Moreover, only reference signs which are required to describe the respective figure are shown in the individual figures for the sake of comprehension. The embodiments illustrated are merely examples of how the gearwheel in accordance with the invention or the transmission stage in accordance with the invention can be embodied and do not represent an exclusive selection. In schematic representation:

FIG. 1 illustrates a gearwheel constructed in accordance with the teachings of the present disclosure in a partially sectioned side view; and

FIG. 2 illustrates the gearwheel from FIG. 1 in a perspective view.

Corresponding reference numerals indicate corresponding parts throughout the several views of the drawings.

### DESCRIPTION

One or more example embodiments of a gearwheel for a backlash-free transmission stage and a transmission stage equipped with such a gearwheel will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

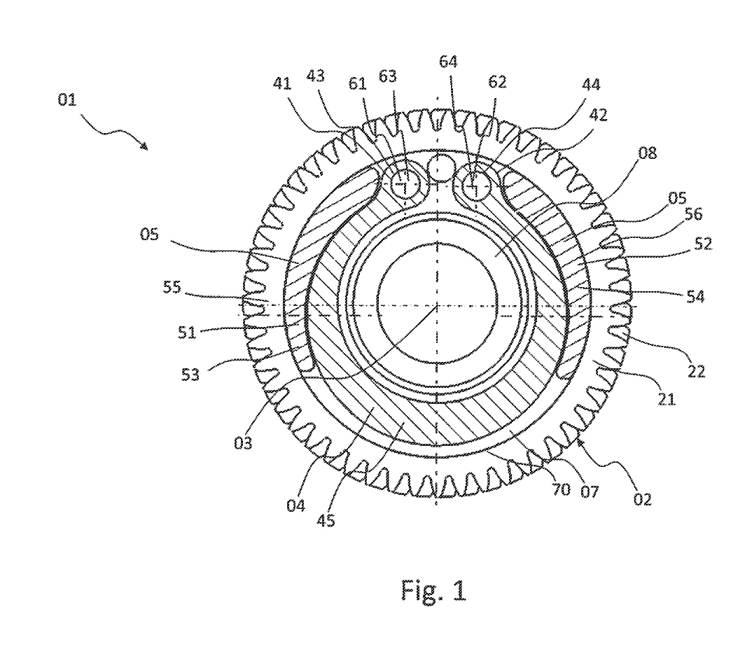

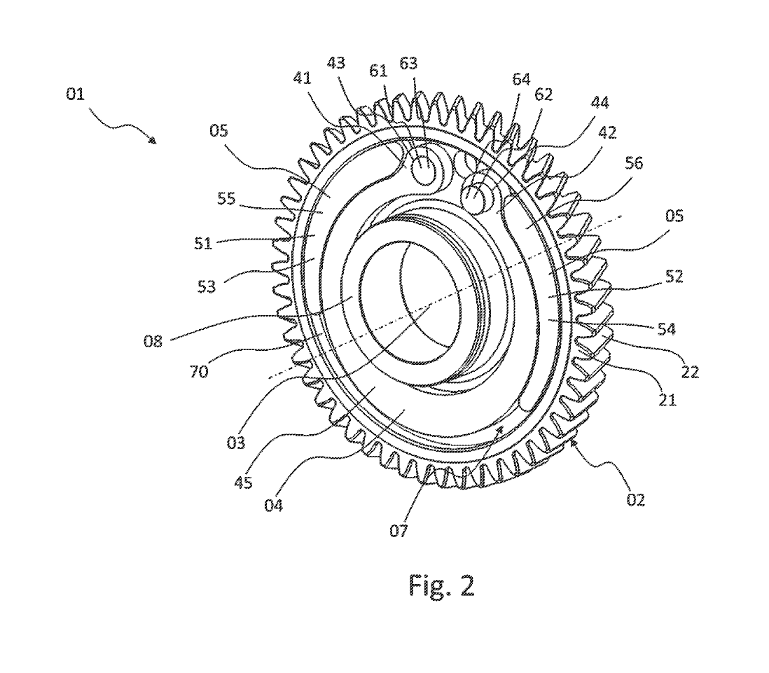

A gearwheel 01, illustrated fully or partially in FIG. 1 and in FIG. 2, for a backlash-free transmission stage includes a gear rim 02. The gear rim 02 includes a first gear rim part 21 and a second gear rim part 22 arranged coaxially therewith. One of the two gear rim parts 21, 22 is used for torque transmission, whereas the other performs backlash compensation.

The two gear rim parts 21, 22 can be turned relative to one another about an axis of rotation 03 of the gearwheel 01. The axis of rotation 03 passes through the centre of the gear rim 02, which coincides with the geometrical centre of gravity of the gear rim 02, when viewed in a plane extending orthogonally to the axis of rotation 03. The axis of rotation 03, which forms a geometrical feature similar to a mirror axis or axis of rotational symmetry rather than a feature in the sense of a mechanical element, such as a shaft, is normal to a plane enclosed by the gear rim 02 and/or formed by the latter. This plane can be a parting plane which divides the gear rim 02 into the gear rim parts 21, 22 thereof, for example.

The gearwheel 01 for a backlash-free transmission stage, which is also referred to as a divided gearwheel 01 or scissors gearwheel 01 or “split gear”, also includes a spring 04 situated between the two gear rim parts 21, 22 and acting in the circumferential direction. The spring 04 preloads the two gear rim parts 21, 22 relative to one another. The gearwheel 01 is further characterized by damping means 05 which damp relative movements between the first gear rim part 21 and/or the second gear rim part 22 and/or the spring 04. The relative movements can comprise torsional vibrations between the two gear rim parts 21, 22 and/or vibrations between the spring 04 and at least one of the two gear rim parts 21, 22 and/or vibrations of the spring 04.

Here, the damping provided by the damping means 05 denotes the phenomenon in accordance with which the amplitude of a vibration of a system which is capable in principle of vibrating, as described at the outset with respect to the prior art, wherein the system consists of a first gear rim part 21, a second gear rim part 22, and a spring 04 which preloads the two gear rim parts relative to one another in the circumferential direction, decreases with time or according to which no vibration at all can occur, depending on the circumstances.

The damping means 05 can comprise one or more elements 51, 52 made of a resilient material that absorbs kinetic energy stemming from a relative movement between the first gear rim part 21 and/or the second gear rim part 22 and/or the spring 04. The flexible material that absorbs kinetic energy is preferably rubber and/or a rubber compound and/or a rubber-like material.

The damping means 05 can comprise one or more impact dampers 53, 54 which damp relative movements that lead to a rest position, in which the two gear rim parts 21, 22 adopt a position relative to one another, in respect of mutual turning in relation to the axis of rotation 03, in which the spring 04 is not capable of turning either of the two gear rim parts 21, 22 relative to the other gear rim part 22, 21.

The two gear rim parts 21, 22 can have a rest position, in which they adopt a position relative to one another, in respect of mutual turning in relation to the axis of rotation 03, in which the spring 04 is not capable of tuning either of the two gear rim parts 21, 22 relative to the other gear rim part 22, 21. In the rest position, the spring 04 can be relaxed and/or the turning of the two gear rim parts 21, 22 relative to one another can be blocked in one direction by one or more stops and/or, in the rest position, the spring 04 acts in both cases on each of the two gear rim parts 21, 22 with forces of equal magnitude in opposite directions.

The spring 04 preferably preloads the two gear rim parts 21, 22 relative to one another, at least outside the rest position.

The damping means 05 can damp relative movements at least in the rest position, and/or around the rest position. Damping preferably increases with increasing proximity to the rest position.

The gearwheel 01 preferably has an abutment 61, 62 for each of the opposite ends 41, 42 of the spring 04 on each gear rim part 21, 22.

The spring 04 can be supported by means of the opposite ends 41, 42 thereof on abutments 61, 62 of the first gear rim part 21, on the one hand, and of the second gear rim part 22, on the other hand, or the spring 04 can be fixed by means of the opposite ends 41, 42 thereof on the abutments 61, 62, wherein the abutments 61, 62 and the spring 04 are connected positively to one another in the region of the opposite ends 41, 42 thereof, as illustrated in FIG. 1 and in FIG. 2. In order to enter a positive engagement, the abutments 61, 62 can, for example, be designed as pins 63, 64 which engage in corresponding openings 43, 44 in the opposite ends 41, 42 of the spring 04.

The abutments 61, 62 are preferably arranged on the two gear rim parts 21, 22 in such a way that they pass one another as the two gear rim parts 21, 22 are turned. This can be accomplished, for example, by means of a radial offset of the two abutments 61, 62 relative to one another in relation to the axis of rotation 03 of the gearwheel 01. An axial offset of the two abutments 61, 62 in relation to the axis of rotation 03 is likewise conceivable.

The damping means 05 can be provided at least in part between the abutment 61, 62 and the opposite ends 41, 42 of the spring 04. For example, the damping means 05 can comprise one or more elements made of flexible material that absorbs kinetic energy arranged between the abutment 61, 62 and the opposite ends 41, 42 of the spring 04.

The damping means 05 can preferably be provided at least in part between at least one of the gear rim parts 21, 22 and the spring 04. For example, the damping means 05 can comprise one or more elements 51, 52 made of flexible material that absorbs kinetic energy arranged between at least one of the gear rim parts 21, 22 and the spring 04.

As a particularly preferred option, the spring 04 is designed as an annular spring 45. The annular spring 45 can be supported by means of the ends 41, 42 thereof, which are situated opposite one another in the circumferential direction, on abutments 61, 62 of the first gear rim part 21, on the one hand, and of the second gear rim part 22, on the other hand, said abutments being designed as stops, for example, as described in DE 201 04 777 U1, for example.

As an alternative, the annular spring 45 can be fixed by means of the ends 41, 42 thereof, which are situated opposite one another in the circumferential direction, on abutments 61, 62 of the first gear rim part 21, on the one hand, and of the second gear rim part 22, on the other hand, said abutments being designed as pins, for example, wherein the spring 04—in the region of the opposite ends 41, 42 thereof—and the abutments 61, 62 are connected positively to one another, as described in DE 201 04 777 U1, for example.

The damping means 05 can be provided at least in part between at least one of the gear rim parts 21, 22 and the annular spring 45. For example, the damping means 05 can be provided at least in part between at least one of the gear rim parts 21, 22 and at least one of the two ends 41, 42 of the annular spring 45, which are situated opposite one another in the circumferential direction.

The spring 04, which is designed as an annular spring 45 for example, can be arranged in a correspondingly shaped recess 07 in one or both gear rim parts 21, 22, said recess being annular in the example of a spring 04 designed as an annular spring 45.

The damping means 06 can be provided at least in part between the spring 04, which is preferably designed as an annular spring 45, and at least one wall 70 bounding a recess 07 in one or both gear rim parts 21, 22 radially towards the outside away from the axis of rotation 03.

The damping means 05 can preferably be provided at least in part between at least one wall 70 bounding a recess 07 in one or both gear rim parts 21, 22 radially towards the outside away from the axis of rotation 03 and at least one of the two ends 41, 42, situated opposite one another in the circumferential direction, of the spring 04, which is preferably embodied as an annular spring 45.

As a particularly preferred option, the damping means 05 comprise two elements 55, 56 made of flexible material that absorbs kinetic energy, which are arranged between the spring 04, which is preferably embodied as an annular spring 45, and a wall 70 bounding a recess 07 in one or both gear rim parts 21, 22 radially towards the outside away from the axis of rotation 03, being arranged in the region of the ends 41, 42 of the spring 04, one element 55, 56 for each end 41, 42 of the spring 04.

In this case, one element 55 can be arranged between the region of one end 41 of the spring 04 and the first gear rim part 21, and one element 56 can be arranged between the region of the remaining end 42 of the spring 04 and the second gear rim part 22.

In this arrangement, one end 41 of the spring 04 is preferably in operative connection with the first gear rim part 21, and the remaining end 42 of the spring 04 is preferably in operative connection with the second gear rim part 22 in order to preload the two gear rim parts 21, 22 relative to one another in the circumferential direction.

As an alternative, both elements 55, 56 can be provided between the spring 04, in the region of the ends 41, 42 thereof, and a wall 70 bounding a recess 07 in just one gear rim part 21 or 22 radially towards the outside away from the axis of rotation 03.

The gearwheel 01 can have a hub 08 which is arranged coaxially with the axis of rotation 03 of the gearwheel 01 and carries the gear rim 02. The spring 04, which is designed as an annular spring 45, for example, can surround the hub 08.

The two gear rim parts 21, 22 can rest snugly one upon the other and can be fixed axially by a snap ring retainer, as described in DE 201 04 777 U1, for example.

The gearwheel 01 can have bevel toothing, as illustrated in FIG. 1 and FIG. 2.

The gearwheel can be embodied as a spur wheel for a spur wheel stage, as illustrated in FIG. 1 and in FIG. 2.

As already mentioned, the gearwheel 01 described above can be part of a backlash-free transmission stage having at least one intermeshing gearwheel pair. One wheel of the gearwheel pair, primarily the driving wheel, is embodied as a gearwheel 01 described above, comprising a gear rim 02 having two gear rim parts 21, 22 which can be turned relative to one another about an axis of rotation 03 of the gearwheel 01 and are preloaded relative to one another by a spring 04 situated between them and acting in the circumferential direction.

The transmission stage can be embodied as a spur wheel stage, as an elliptical wheel stage or as a bevel wheel stage. An embodiment in the form of a rack stage used, for example, as a linear drive is likewise conceivable.

Advantages over the prior art are a reduction in wear through a reduction in the amplitude and damping of the vibrations of the spring 04 and a concomitant increase in service life and operational reliability. This is achieved by inserting damping elements 51, 52, 53, 54, 55, 56, such damping elements preferably being composed of rubber.

The invention is industrially applicable especially in the area of production of backlash-free gearwheels and transmission stages fitted therewith.

The invention has been described with reference to a preferred embodiment. However, as a person skilled in the art will understand, modifications or changes to the invention can be made without exceeding the scope of protection of the following claims.

What is claimed is:

1. A gearwheel for a backlash-free transmission stage comprising: a gear rim having a first gear rim part and a second gear rim part which is arranged coaxially with the first gear rim part, such that the two gear rim parts can be turned relative to one another about an axis of rotation; a spring situated between the two gear rim parts acting in the circumferential direction and which preloads the two gear rim parts relative to one another; and damping means for damping relative movements between the first gear rim part and/or the second gear rim part and/or the spring.

2. The gearwheel in accordance with claim 1, wherein the damping means includes one or more elements made of a flexible material that absorbs kinetic energy stemming from a relative movement between the first gear rim part and/or the second gear rim part and/or the spring.

3. The gearwheel in accordance with claim 2, wherein the flexible material that absorbs the kinetic energy is rubber and/or a rubber compound and/or a rubber-like material.

4. The gearwheel in accordance with claim 1, wherein the damping means comprise one or more impact dampers which damp relative movements that lead to a rest position, in which the two gear rim parts adopt a position relative to one another, in respect of mutual turning in relation to the axis of rotation, in which the spring is not capable of turning either of the two gear rim parts relative to the other gear rim part.

5. The gearwheel in accordance with claim 1, wherein increasing damping is provided with increasing proximity to a rest position.

6. The gearwheel in accordance with claim 1, further including an abutment for each of the opposite ends of the spring on each gear rim part.

7. The gearwheel in accordance with claim 6, wherein the spring is supported by means of the opposite ends thereof on abutments of the first gear rim part, on the one hand, and of the second gear rim part, on the other hand.

8. The gearwheel in accordance with claim 6, wherein the spring is fixed by means of the opposite ends thereof on the abutments, wherein the abutments and the spring are connected positively to one another in the region of the opposite ends thereof.

9. The gearwheel in accordance with claim 6, wherein the abutments are arranged on the two gear rim parts in such a way that they pass one another as the two gear rim parts are turned.

10. The gearwheel in accordance with claim 6, wherein the damping means is provided at least in part between the abutment and the opposite ends of the spring.

11. The gearwheel in accordance with claim 1, wherein the damping means is provided at least in part between at least one of the gear rim parts and the spring.

12. The gearwheel in accordance with claim 1, wherein the spring is designed as an annular spring.

13. The gearwheel in accordance with claim 1, wherein the spring is arranged in a correspondingly shaped recess in one or both gear rim parts.

14. The gearwheel in accordance with claim 13, wherein the damping means are provided at least in part between the spring and at least one wall bounding a recess in one or both gear rim parts radially towards the outside away from the axis of rotation.

15. A transmission stage having at least one intermeshing gearwheel pair, wherein one wheel of the gearwheel pair is embodied as a gearwheel for a backlash-free transmission stage including a gear rim having two gear rim parts which can be turned relative to one another about an axis of rotation of the gearwheel and are preloaded relative to one another by a spring, wherein the spring is situated between the two gear rim parts and acts in a circumferential direction, and wherein the gearwheel is a gearwheel according to claim 1.

16. A gearwheel for use in an intermeshing gearwheel pair for a backlash-free transmission stage, the gearwheel comprising: a gear rim including a first gear rim part and a second gear rim part arranged coaxially for relative rotation about a common axis of rotation; a spring disposed between the first and second gear rim parts and which acts in a circumferential direction to preload each of the first and second gear rim parts relative to the other; and damping means for damping relative movement between the first and second gear rim parts and the spring.

17. The gearwheel in accordance with claim 16, wherein the damping means includes one or more damping elements made from a resilient material for absorbing kinetic energy associated with the relative movement between the first and second gear rim parts and the spring.

18. The gearwheel in accordance with claim 17, wherein the spring is an annular spring retained in a recess formed in the gear rim, and wherein a pair of the damping elements are arranged between an outer surface of the annular spring and a wall surface bounding the recess.

19. The gearwheel in accordance with claim 16, wherein the damping means includes at least one impact damper operable to damp the relative movement that leads to a rest position between the first and second gear rim parts, and wherein in the rest position, the spring is inhibited from rotating either of the first and second gear rim parts relative to the other.
